(19) United States
(12) Patent Application Publication
(10) Pub. No.: US 2007/0145121 A1
(43) Pub. Date: Jun. 28, 2007

(54) Authentication system for the authorization of a transaction using a credit card, ATM card, or secured personal ID card

(75) Inventors: Menashe Foliad Dallal, Great Neck, NY (US); David Naim Dallal, Roslyn, NY (US); Alice Chuan Li, Tracy, CA (US)

Correspondence Address: EZRA SUTTON, P.A.;Plaza 9 Building, 900 Route 9 North, Woodbridge, NJ, 07095, US

(73) Assignee: Menashe Fouad Dallal

(21) Appl. No.: 11/398,211

(22) Filed: Apr. 4, 2006

Related U.S. Application Data
(60) Provisional application No. 60/754,732, filed on Dec. 29, 2005.
(60) Provisional application No. 60/753,231, filed on Dec. 23, 2005.

(51) Int. Cl. G06K 5/00

(52) U.S. Cl. 235/380

(57) ABSTRACT

An authentication system for the authorization of a transaction card, such as a credit card, an ATM card or a secured personal ID card by a user. The authentication system includes a writer authenticator input unit for inputting and encrypting of personal authentication data and information of a user to the transaction card for security purposes. The transaction card is defined to be a credit card, an ATM card or a secured personal ID card. The authentication system further includes a cardholder input unit for the user to insert the transaction card of the user, and a vendor unit for use by a vendor for verifying the personal authentication data information of the user when using the transaction card for completing a transaction. Additionally, the authentication system includes the computer system for inputting encrypted personal data and medical information to the transaction card by the user.

### RELATED APPLICATIONS

Applicant has filed Provisional Application Ser. No. 60/754,732 on Dec. 29, 2005, and has also filed Provisional Application Ser. No. 60/753,231 on Dec. 23, 2005.

### FIELD OF THE INVENTION

The present invention relates to a self service biometric data input and authentication system for the authorization of a transaction using a credit card or an ATM card having a magnetic strip and a smart chip, or a personal ID card with a smart chip with or without a magnetic strip. The system authenticates the cardholder to the credit card, ATM card or personal ID card, and it does not have any affect on the present banking system or the present method of conducting a transaction. It merely elevates the credit card to a multi-function credit card that could in an emergency situation save the card owner's life. The invention allows the user to add-on additional security. More particularly, the invention is a self service writer/authentication system that allows the user or issuer of an Identify credential to select multiple layers of additional security protection, as desired by the cardholder or issuer of an Identity credential. Further, the user at his/her discretion, without a third party intervention, can input or copy all personal data of the user from one credit card or an ATM card to another by first being authenticated as the owner of both or multiple cards. Also, ID cards issued by Issuer of Identity Credential will be exempt.

### BACKGROUND OF THE INVENTION

Security devices and authenticating devices are well known in the prior art, and have recently become of greater importance, because of the substantial increase in the amount of identity theft. This includes credit cards or ATM cards being stolen and used, as well as social security numbers and other information being stolen and used. Current devices have not been able to decrease the amount of identity theft. New technology is needed to overcome these problems in a more efficient and secure manner to substantially decrease the amount of identity theft.

Presently, most vendors do not check the identity of the cardholder when financial transactions are processed. As long as a card is presented to the vendors, it will be swiped and a signature collected on the receipt. However, identity checkups are rare because vendors do not match the signature with that on the driver's license. Therefore, anyone can easily get away with identity or card theft. Subsequently, there are many complaints of charges that cardholders claim they never made.

In 2003, the Federal Trade Commission (FTC) conducted a survey that revealed businesses and financial institutions have sustained a $47.6 billion loss from ID theft in one year alone. This total represents victimization of 9.91 million people or 4.6% of the population. More disturbing, the upward trend of fraud in recent years suggests that more individuals are taking advantage of the vulnerabilities of the financial transaction system presently in use.

Recently, British financial institutions started issuing IC chip cards to their cardholders. Although they use PIN numbers to protect the IC cards, fraud rates actually have not seen much decrease. Many cardholders report they actually do not want to use their PIN numbers because thieves have started to steal both the PIN number and the IC chip card.

One of the new products on the card market is the contact-less cards introduced by American Express and Chase Manhattan bank recently. Though this type of card increases the speed of transaction, it is not so secure especially in terms of identity checks. Specialists in the field of information security have raised concerns regarding these contact-less cards, as these contact-less cards are constrained by the low power in these battery-less devices. These devices do not have batteries so the circuitry can only compute very simple functions. Therefore, getting security with such a low power environment is quite difficult.

There remains a need for security devices which allows the user or user of Identity credential to select as many layers of protection as they believe is needed to prevent identity theft. For example, the user or issuer of an Identity credential should be able to select fingerprints, specific codes, pin numbers, photographs, expiration-dates, and other means to prevent identity theft.

### DESCRIPTION OF THE PRIOR ART

Security devices and authenticating devices using fingerprints, retinal scans, voice prints, biometric sensors, photographs, personal information and personal codes having various structures, designs and configurations have been generally disclosed in the prior art.

For example, U.S. Patent Application Publication No. 2005/0212657 to Simon discloses an identity verification system that includes a self-authenticating identity card and a card reader. The self-authenticating card has a programmable microchip with data pertaining to the authorized card bearer, including data for a stored biometric feature, such as a fingerprint, a retinal scan, a voice print, a DNA sequence, etc. The card also includes a biometric sensor that senses an applied biometric feature and a data lock that releases data upon determination of a match between the stored and the applied biometric features. In order to self-authenticate the card, the card bearer must provide the applied biometric feature to the one fingerprint previously stored in the card. This prior art publication does not disclose the methods of scanning and storing vital biometrics (fingerprints, personal information, pin numbers or pictures) onto the smart chip either by themselves or by the issuer of an Identity credential. Nor does it allow the user or issuer of an Identity credential to select multiple layers of security protection, as needed.

None of the prior art discloses or teaches an authentication system that allows the cardholder to select and input multiple layers of security protection, as needed.

Accordingly, it is an object of the present invention to provide an authentication system for the authorization of a transaction using a credit card, an ATM card, or a secured personal ID card which allows the cardholder to select multiple layers of security protection as needed. The Cardholder is not obligated to adhere to this process, he/she can continue using their card the way it has been used thus far with the magnetic strip only.

Another object of the present invention is to provide an authentication system that includes a Writer/Authenticator Input Unit that is a stand alone unit or with a computer attached to it; a Vendor/Cardholder Authenticator Input Unit that connects to a credit card terminal that has the capability of scanning and saving fingerprints and codes to the smart chip. A handheld read only Emergency Reader Unit for use by medical and emergency personals without showing any bank's information. All utilizing the same protocol and with provisions of adding other protocols.

Another object of the present invention is to provide an authentication system that has the features where cardholders, through the Writer/Authenticator Input Unit, copy the card's magnetic strip information to the smart chip, scan and save multiple fingers, insert personal code, take their own picture and save it into the smart chip, at their own discretion. With the aid of the computer and specialized software insert their medical -and emergency data into the smart chip.

Another object of the present invention is to provide an authentication system that has the Writer/Authenticator Input Unit that also is a biometric comparer and verifier with a user-friendly menu, and red and green indicator lights. The Writer/Authenticator Input Unit also has the capability of searching all fingerprints stored on the smart chip for such time as the card holder mistakenly scans the wrong finger.

Another object of the present invention is to provide an authentication system that can be used in any place such as retailers/department stores, banks, schools, lab testing facilities, office buildings, computer rooms, government agencies and military branches.

Another object of the present invention is to provide an authentication system that includes the handheld Emergency Reader Unit for use by emergency personnel, such as police officers, paramedics, firemen, doctors at hospitals, ambulance providers, in which the cardholder's credit card or personal ID card is inserted into the Emergency Reader Unit and emergency personnel can read the vital medical data that the cardholder has inputted through the Writer/Authenticator Input Unit.

Another object of the present invention is to provide an authentication system that integrates and engages with the security database that resides on LAN or WAN servers.

Another object of the present invention is to provide an authentication system that can copy all stored fingerprints, picture, codes, and personal data previously stored on the smart chip from one credit card or ATM card to another.

Another object of the present invention is to provide an authentication system that can be mass-produced in an automated and economical manner and is readily affordable for the vendor.

### BRIEF DESCRIPTION OF THE DRAWINGS

Further objects, features, and advantages of the present inventions will become apparent upon the consideration of the following detailed description of the presently-preferred embodiment when taken in conjunction with the accompanying drawings, wherein:

FIG. 1 is a perspective view of the Computer Monitor and Keyboard of the preferred embodiment of the present invention showing a computer system having a computer tower situated behind the wall that is connected to the Writer/Authenticator Input Unit through either a serial RS-232 or USB port; wherein the computer monitor and the computer keyboard face the cardholder so he/she can input his/her emergency/medical data onto the smart chip;

FIG. 2 is a perspective view of the Writer/Authenticator Input Unit of the present invention for use either with a credit card having a magnetic strip and a smart chip, or a personal ID card with a smart chip. The smart chip can be filled by utilizing the Writer/Authenticator Input Unit as a stand along or with the aid of the computer. If emergency/medical data is preferred not to be included in the chip, the Writer/Authenticator Input Unit can be operated as a stand alone unit without utilizing the computer;

FIG. 3 is a perspective view of the Vendor/Cardholder Authenticator Input Unit stand of the present invention showing a first side wall of the Vendor Unit that faces the vendor, or if used in testing facilities, the examiner. The stand encapsulates all the wirings and connectivity to both sidewalls along with the credit card terminal line, phone line, electrical wires and Ethernet cable connections to LAN or WAN;

FIG. 4 is a perspective view of the Vendor/Cardholder Authenticator Input Unit stand of the present invention showing a second side wall of the Cardholder Input Unit for the user for authentication of the cardholder;

FIG. 5 is a perspective view of the Vendor Unit of the present invention showing the vendor side having an LCD screen, a pair of information light indicators, and a bypass function key. This unit of the present invention intercepts the customer's transaction submitted via the credit card terminal. Upon authenticating the cardholder to the card, releases the transmitted transaction to the credit card company. The LCD screen facing the vendor shows the cardholder picture and credit card number along with expiration date. The red indicator light shows the cardholder has failed the authentication or the card has expired, while the green indicator light shows that information exists on the smart chip and the cardholder has been authenticated. Once authentication is complete, the transmitted transaction is automatically released. The bypass switch of the Vendor/Cardholder Unit is for such time as authentication is of no concern;

FIG. 6 is a perspective view of the Cardholder Input Unit of the present invention showing the Cardholder Input Unit that faces the cardholder, having a fingerprint scanner, a hand pad section with finger orientation and corresponding numbers, a code input section, a pair of info light indicators, and a card slot. The cardholder after the card was swiped or inserted though the credit card terminal, inserts the same card into the slot, assuming the smart chip contains authentication data (fingerprint, picture, personal code), the screen on the vendor side will display the picture with the card number and expiration date of the cardholder. The lit finger digits on the cardholder side will indicate the fingers that can be used for authentication. The cardholder can choose any of the lit fingers for authentication. However, if the cardholder mistakenly scans the wrong finger, the unit will search all the stored fingerprints for a match. If the cardholder chooses not to use his/her fingers for authentication, verification will rest on the user's personal code number. The picture of the owner of the card and the credit card number along with the expiration date will be displayed on the vendor side for vendor's reassurance. If the date has expired, or finger or code, do not match, the red light will turn on;

FIG. 7 is a front perspective view of the handheld Emergency Reader Unit of the present invention showing the Emergency Reader which is a battery-operated unit having an LCD screen, a pair of info lights, and a scroller button. Emergency personnel, when immediate medical information is needed, can obtain the credit card and insert it in their Emergency hand-held unit and read the vital medical information that is on the card, (blood type, RH +or− type) medical problems, allergies to medication, doctor's telephone number, etc. With this information treatment can commence immediately and lives can be saved. The scroll button moves the LCD screen up and down for reading all data;

FIG. 8 is a rear perspective view of the Emergency Reader Handheld Unit of the present invention showing the Emergency Reader Handheld Unit having a rear wall with a battery cover, and a battery compartment for receiving batteries therein;

FIG. 9 is a schematic representation of the authentication system of the present invention showing a first flow chart using the Writer/Authenticator Input Unit for the initial processing and operational steps for use by the cardholder or issuer of an Identity credential to achieve the user's biometric/personal data and verification;

FIG. 10 is a schematic representation of the authentication system of the present invention showing a second flow chart using the Writer/Authenticator Input Unit for the initial processing and operational steps by a user or issuer of an Identity of credential to achieve the user's biometric/personal data input;

FIG. 11 is a schematic representation of the authentication system of the present invention showing a third flow chart using the Writer/Authenticator Input Unit for the initial processing and operational steps by a user or issuer of an Identity credential to achieve user input authentication for the fingerprint menu mode;

FIG. 12 is a schematic representation of the authentication system of the present invention showing a fourth flow chart using the Writer/Authenticator Input Unit for the initial processing and operational steps by a user or issuer of an Identity credential to achieve the taking and saving a preferred picture by following the picture menu mode;

FIG. 13 is schematic representation of the authentication system of the present invention showing a fifth flow chart using the Writer/Authenticator Input Unit for processing additional multiple layers of security operational steps by a cardholder to achieve user authentication for the Personal Codes/Pin menu mode;

FIG. 14 is schematic representation of the authenticator system of the present invention showing a sixth flow chart using the Writer/Authenticator Input Unit for the initial processing and operational steps by a cardholder to achieve user authentication for the personal and medical information menu mode; and

FIG. 15 is schematic representation of the authenticator system of the present invention showing a seventh flow chart using the Writer/Authenticator Input Unit for the initial processing and operational steps by a cardholder to achieve user authentication for copying biometric and personal information from one credit card to another though the Copy Card menu.

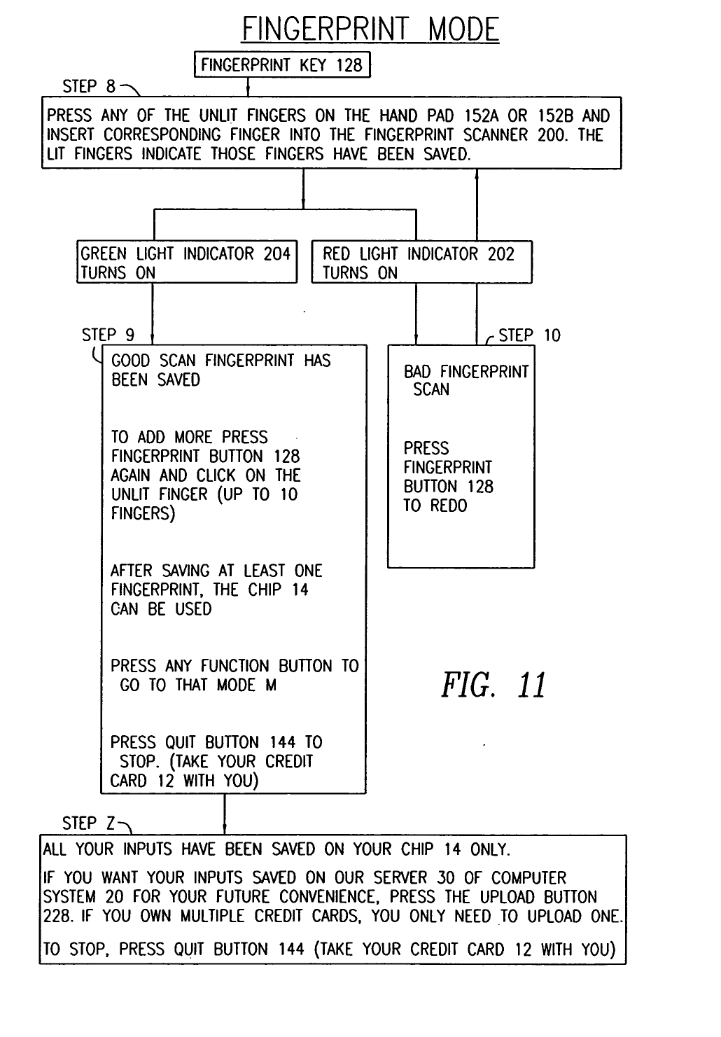

FIG. 11 through FIG. 15 of the present invention show that all input information on the chip can be uploaded to data servers through the Writer/Authenticator Input Unit by pressing the upload switch if the cardholder's desires.

### DETAILED DESCRIPTION OF THE PREFERRED EMBODIMENT

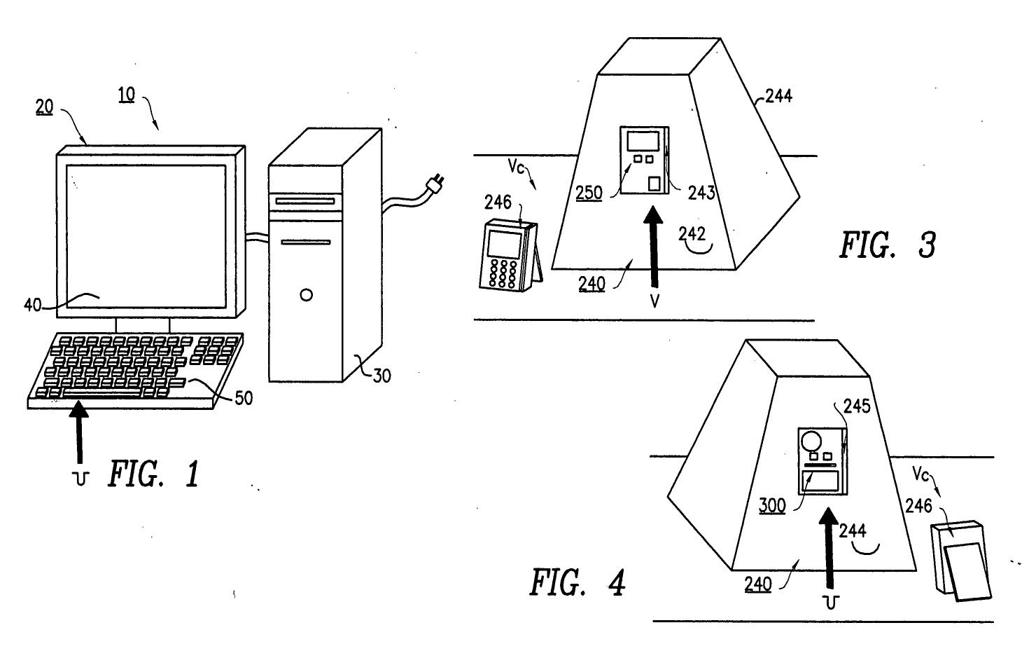

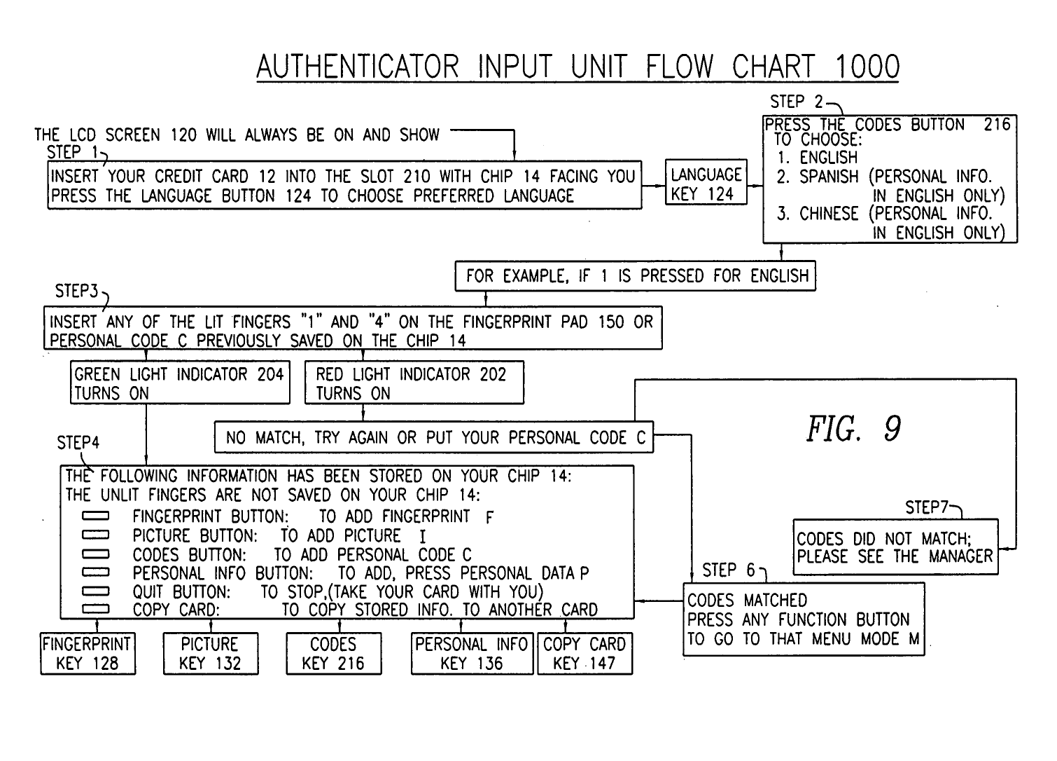

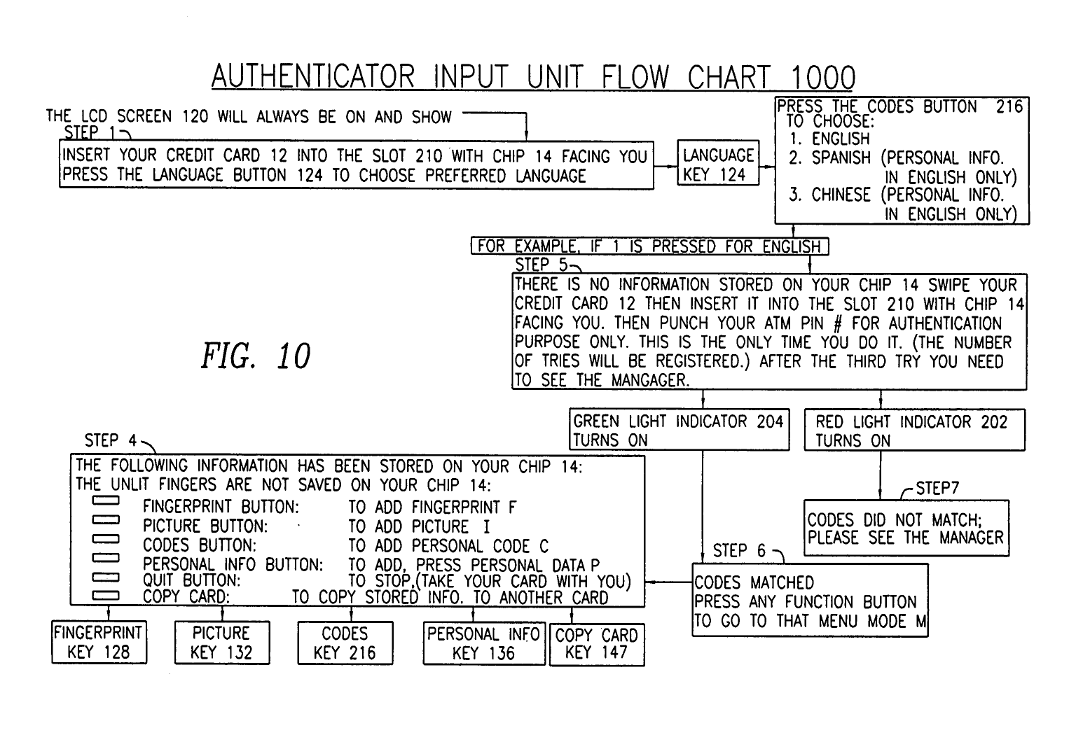

The authentication self service system 10 for purchases by a credit card or by an ATM Card 12 and its component devices of the preferred embodiment of the present invention are represented in detail by FIGS. 1 through 8 of the patent drawings. The method 1000 of utilizing the authentication system 10 having various processing and operational steps are disclosed in the preferred embodiment of the present invention and is represented in detail by FIGS. 9 to 15 of the patent drawings.

The authentication self-service system 10 hardware includes the following component devices: a Writer/Authenticator Input Unit 100; a Vendor/Cardholder unit 250 and 300; an Emergency Reader unit 500; a standard computer system 20 having a computer tower 30 behind the wall, a computer monitor/screen 40 and computer keyboard 50.

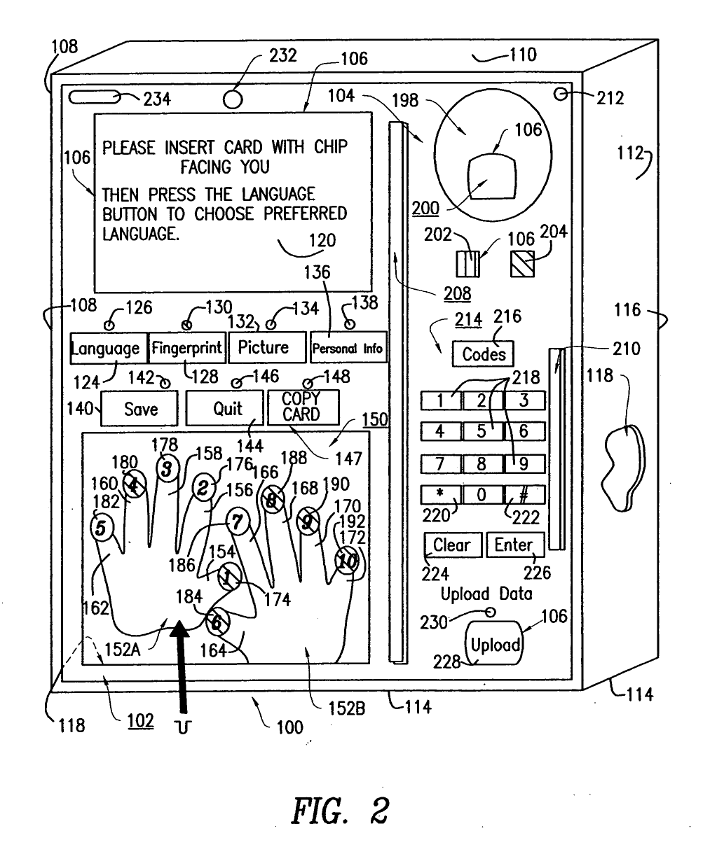

The authentication system 10 uses a credit card or an ATM card 12 having a magnetic strip and smart chip 14 or a secured personal ID card with or without magnetic strip 13 embedded within the credit card or ATM card or personal ID card 12, as shown in FIG. 2 of the drawings.

The computer system 20 attached to Writer/Authenticator unit 100, as shown in FIG. 1, is used for the inputting of encrypted personal data P by a user U. Such personal data/information P can include items relating to medical history; allergies to medicine/drugs; current pharmacological usage; doctor contacts; emergency contacts; name of parents, date of birth, place of birth for security purposes; current name, address, city, state and phone numbers (work, home and cell); passport number, issuing country or driver license number; email address and other pertinent personal data P. The computer system 20 will generate various screens for the inputting of the personal data P that the user would like to input at his/her discretion.

The Writer/Authenticator Input Unit 100, as shown in FIG. 2, is a self-service unit, used for the encrypted inputting of various processing data needed by a user U or issuer of identity credential for the input and verification of key data to the user's smart chip 14 on the credit card or ATM card 12. For example, the Writer/Authenticator Input Unit 100 copies the information from magnetic strip 13 of credit card onto the smart chip 14 of the same credit card 12; then verifies the information between the magnetic strip and smart chip. If the smart chip has stored medical/personal information, or stored picture I and cardholder fingerprints F; it will identify the scanned fingers and gives the cardholder choices for adding any unsaved fingerprints F, picture I, or personal code number C, or medical/personal data P, or copy from one credit card 12 to another.

Further, the Writer/Authenticator Input Unit 100 can take a picture/photograph image I of the user U and inserts the photograph image I onto the smart chip 14 of credit card 12. Additionally, the Writer/Authenticator Input Unit 100 saves user created personal codes C onto the smart chip 14 of credit card 12, such personal codes C can include the user's birthday, favorite number, social security number, an anniversary date. The Writer/Authenticator input unit 100 also contains an upload data function key 228 to upload all inputted information P to the computer system 20 and or LAN/WAN servers from the user's smart chip 14 on credit card 12. After pressing the upload button, the screen will ask to confirm by pressing the [*] key for “yes” or [#] key for “no”. Also, the Writer/Authenticator Input Unit 100 is able to communicate to the user U in multiple languages L (at least three (3) languages) such as English, Spanish and Chinese. Each of the aforementioned modes M on the Writer/Authenticator Input Unit 100 has its own menu function keys that guides the user U via an LCD screen 120 on the Writer/Authenticator Input Unit 100. These menu function keys include a language function key 124; a fingerprint function key 128; a photograph/picture function key 132; a codes function key 216; a personal information function key 136; a save function key 140; an exit/quit function key 144; and a copy card function key 147; The user U has the option of adding one or all of the previously mentioned menu functions.

As shown in FIG. 2, the Writer/Authenticator Input Unit 100 includes a unit housing 102 being substantially rectangular shaped. The unit housing 102 includes a front panel cover 104 having multiple openings 106 for receiving various processing menu keys function lights, camera, and flashlight, and the like. Side walls 108, 110, 112 and 114 and a back wall 116 which contains ports (RS-232, USB, RJ45, RJ9 phone jack) for forming an interior compartment 118. The front panel cover 104 of Writer/Authenticator Input Unit 100 includes an LCD screen 120, a language function key 124 having a function in-use green light indicator 126, a fingerprint function key 128 having a function in-use green light indicator 130, a picture function key 132 having a function in-use green light indicator 134, a personal info function key 136 having a function in-use green light indicator 138, a save function key 140 having a function in-use green light indicator 142, a quit (exit) function key 144 having a function in-use green light indicator 146, and a copy card function key 147 having a function in-use green light indicator 148. Further, the front panel cover 104 includes a fingerprint pad section 150 having a pair of handprints 152A and 152B thereon. Each of the handprints 152A and 152B includes finger digits 154 (left thumb), 156 (index finger), 158 (middle finger), 160 (ring finger), 162 (pinky finger); 164 (right thumb), 166 (index finger), 168 (middle finger), 170 (ring finger) and 172 (pinky finger), respectively, as shown in FIG. 2 of the drawings. Each of the finger digits 154 to 172 includes a finger function key 174, 176, 178, 180, 182, 184, 186, 188, 190 and 192, respectively, thereon. Each of the finger function keys 174 to 192 has a numeric indicia thereon where the finger function key 174 has the number “1” thereon, the finger function key 176 has the number “2” thereon, the finger function key 178 has the number “3” thereon, the finger function key 180 has the number “4” thereon, the finger function key 182 has the number “5” thereon, the finger function key 184 has the number “6” thereon, the finger function key 186 has the number “7” thereon, the finger function key 188 has the number “8” thereon, the finger function key 190 has the number “9” thereon, and the finger function key 192 has the number “10” thereon. Each of the finger function keys 174 to 192 includes a function in-use green light indicator 194 for indicating which finger has been stored in the smart chip.

Additionally, as shown in FIG. 2, the front panel cover 104 includes a concave indentation compartment (well) 198 for receiving a fingerprint scanner 200 therein. The front panel cover 104 also has an info red light indicator (authentication processing failed) 202, an info green light (successful verification) indicator 204, and a unit power on or off indicator 212. The front panel cover 104 also includes a swipe credit card slot 208 and an insert smart chip card slot 210 for the credit card or ATM card 12. Additionally, the front panel cover 104 includes a code input section 214. The code input section 214 includes a codes function key 216, a plurality of number function keys 218 (for numbers 1, 2, 3, 4, 5, 6, 7, 8, 9 and 0), a star (*) function key 220 for conformation purpose to indicate “yes”, and a pound (#) function key 222 for conformation purpose to indicate “no”. The code input section 214 also includes a clear function key 224, an enter function key 226, and an upload data function key 228 having a function in-use green light indicator 230. The info red light indicator 202 when illuminated indicates that the smart chip 14 on credit card or ATM card 12 does not have user information, or is empty of information, or the user information on the smart chip 14 does not match. Conversely, the info green light indicator 204 when illuminated indicates that the smart chip 14 on credit card or ATM card 12 has pertinent user information for authentication purposes. Further, the Writer/Authenticator Input Unit 100 includes a digital camera 232 having a flash 234 built into the front panel cover 104, as depicted in FIG. 2 of the drawings. Digital camera 232 is used in conjunction with the picture function 132.

As shown in FIGS. 3 and 4, the Vendor/Cardholder Unit for vendor 250 and for cardholder 300 is set within a trapezoidal-shaped stand 240. The trapezoidal-shaped stand 240 has a first side wall 242 facing vendor V having a first inset compartment 243 for receiving the vendor part of Vendor/Cardholder Unit 250 therein. The stand 240 has a second side wall 244 (opposite to first side wall 242) having a second inset compartment 245 for receiving the cardholder part of Vendor/Cardholder Unit 300 therein. Internal connection wires (not shown) connect each of the units 250 and 300 together for the authentication process of vendor V and customer U when purchasing goods or services. The stand 240 will be positioned on the vendor's counter V_{C} next to a standard credit card terminal 246 (Vendor/Cardholder Unit will intercept transactions sent by the credit card terminal until verified, but not interfere with or alter the transaction), as shown in FIGS. 3 and 4 of the patent drawings.

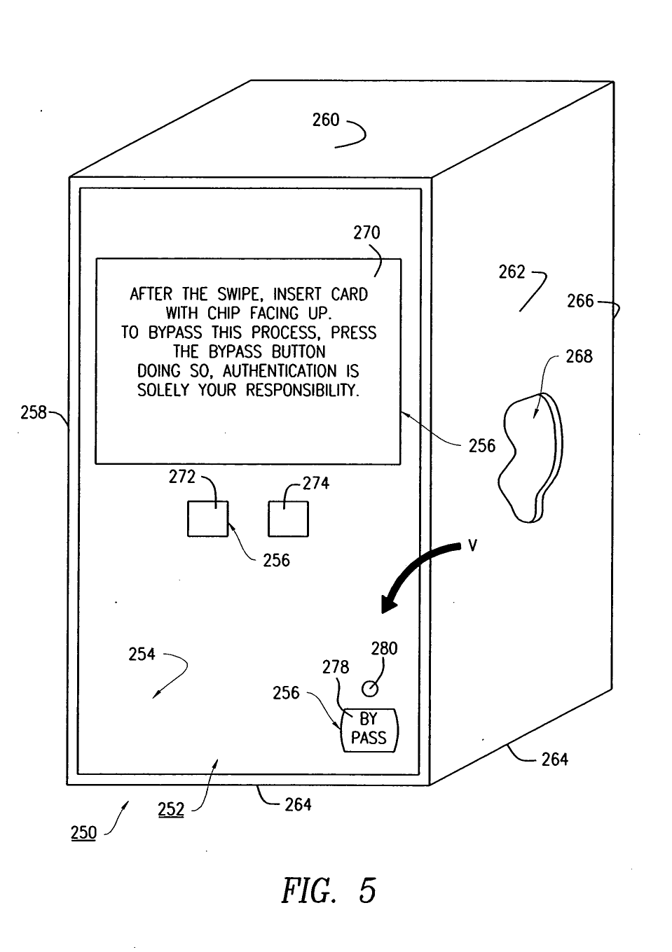

As shown in FIG. 5, the Vendor/Cardholder Unit 250 for vendor V includes a unit housing 252 being substantially rectangular-shaped. The unit housing 252 includes a front panel cover 254 having multiple openings 256 for receiving various processing menu keys, function lights and the like. The unit housing 252 also includes side walls 258, 260, 262 and 264 and a back wall 266 for forming an interior compartment 268. The front panel cover 254 of the Vendor/Cardholder Unit 150 includes an LCD screen 270, an info red light indicator 272, an info green light indicator 274 therein, and a bypass function key 278 having a function in-use green light indicator 280. The info red light indicator 272 when illuminated indicates that the smart chip 14 on credit card or ATM card 12 does not have user information, or is empty of information, or the user information on the smart chip 14 does not match. Conversely, the info green light indicator 274 when illuminated indicates that the smart chipl4 on credit card or ATM card 12 has pertinent user information for authentication purposes, or the user information on the smart chip 14 matches the cardholder.

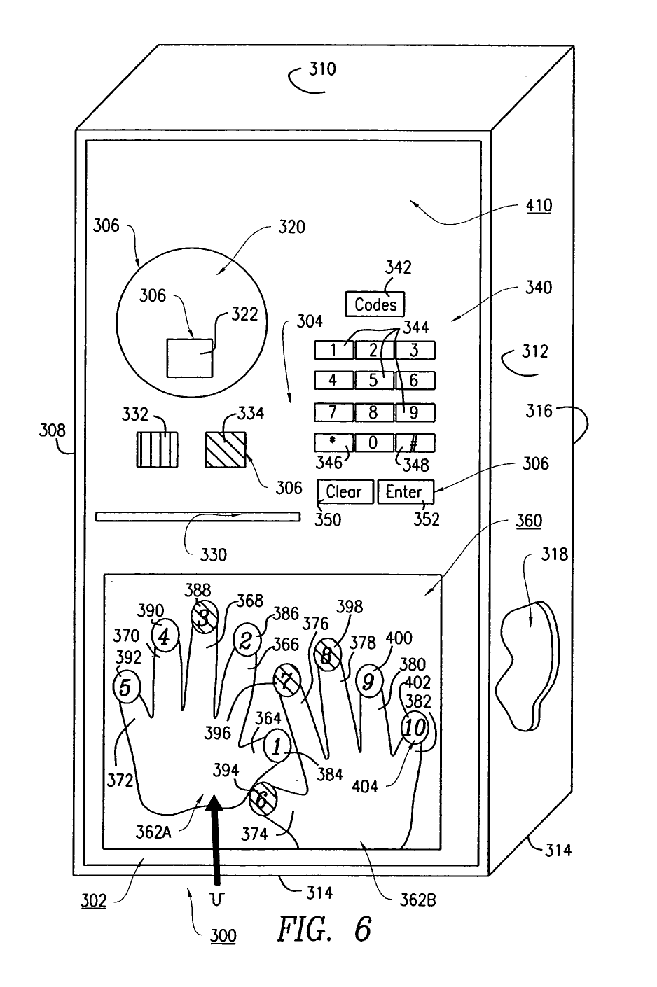

As shown in FIG. 6, the Vendor/Cardholder Unit 300 for user U includes a unit housing 302 being substantially rectangular-shaped. The unit housing 302 includes a front panel cover 304 having multiple openings 306 for receiving various processing menu keys, function lights, and the like. The unit housing 302 also includes side walls 308, 310, 312, and 314 and a back wall 316 for forming a interior compartment 318. The front panel cover 304 of the Vendor/Cardholder Unit 300 for user U includes a concave indentation compartment (well) 320 for receiving a fingerprint scanner device 322 therein. The front panel cover 304 also has a credit card receiver slot 330 for receiving the credit card 12 therein, an info red light indicator 332 and an info green light indicator 334. The function of each red and green info light indicators 332 and 334 have been previously described in the aforementioned sections. The front panel cover 304 further includes a code input section 340. The code input section 340 includes a codes function key 342, a plurality of number function keys 344 (for numbers 2, 3, 4, 5, 6, 7, 8, 9, and 0), a star(*) function key 346, and a pound (#) function key 348. The code input section 340 also includes a clear function key 350 and an enter function key 352.

Further, the front panel cover 304 includes a fingerprint pad section 360 having a pair of handprints 362A and 362B thereon. Each of the handprints 362A and 362B include finger digits 364 (left thumb), 366 (index finger), 368 (middle finger), 370 (ring finger), 372 (pinky finger), 374 (right thumb), 376 (index finger), 378 (middle finger), 380(ring finger) and 382 (pinky finger), respectively, as shown in FIG. 6 of the drawings. Each of the finger digits 364 to 382 includes a finger key 384, 386, 388, 390, 392, 394, 396, 398, 400 and 402, respectively, thereon. Each of the finger function keys 384 to 402 has a numeric indicia thereon where the finger function key 384 has the number “1” thereon, the finger function key 386 has the number “2” thereon, the finger function key 388 has the number “3” thereon, the finger function key 390 has the number “4” thereon, the finger function key 392 has the number “5” thereon, the finger function key 394 has the number “6” thereon, the finger function key 396 has the number “7” thereon, the finger function key 398 has the number “8” thereon, the finger function key 400 has the number “9” thereon, and the finger function key 402 has the number “10” thereon. Each of the finger function keys 384 to 402 includes a function fingerprint stored green light indicator 404 for indicating which finger function key 384 to 402 has been stored in the card by the user U. Additionally, the front panel cover 304 includes the credit card receiver slot 330 for receiving a credit card or ATM card 12 which has smart chip 14 thereon with biometric and or security information P.

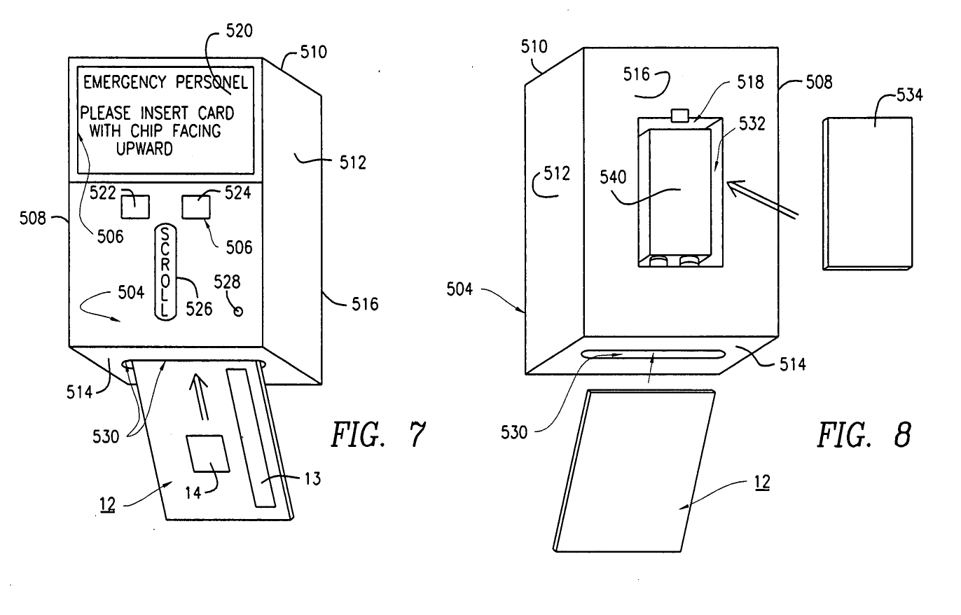

The authentication system 10 further includes a handheld Emergency Reader Unit 500, as shown in FIG. 7, for use by emergency personnel, firemen, paramedics, police officers and doctors at hospitals, doctors' offices and the like, in case of an accident or any kind of medical emergency. The Emergency Reader hand-held unit 500 is battery operated using a standard 9-volt battery or multiple AA batteries, etc. The Emergency Reader hand-held unit 500 includes a unit housing 502 being substantially rectangular-shaped. The unit housing 502 includes a front panel cover 504 having multiple opening 506 for receiving various processing menu keys, function lights and a scroll function key 526, side walls 508, 510, 512 and 514, and a back wall 516 for forming an interior compartment 518. The front panel cover 504 includes an LCD screen 520, an info red light indicator 522, an info green light indicator 524, a scroll function key 526, and a power on blue light indicator 528. The side wall 514 includes a card slot 530 for receiving the user's card 12 having the smart chip 14 thereon. The back wall 516, as shown in FIG. 8, includes a battery opening 532 having a battery cover 534 thereon, and a battery compartment 536 within the unit's interior compartment 518. The battery compartment 536 is used to receive standard batteries 540 such as AA batteries, AAA batteries, a 9-volt battery and the like. As previously mentioned, the function of each red and green info light indicators 522 and 524 have been described, such that the red info light indicator 522 when illuminated indicates that no information is available or saved and the green info light indicator 524 when illuminated indicates information exists on the smart chip 14 of credit card or ATM card or personal ID card 12.

### OPERATION OF THE PRESENT INVENTION

As shown in FIGS. 1 through 15 of the patent drawings, the self service authentication system 10 for using a credit card or ATM card 12, having a magnetic strip 13 and a smart chip 14 for inputs personal data, when purchasing of goods, products and/or services by a cardholder, it operates in the following manner.

The cardholder initially uses his/her credit card or ATM card 12 to copy magnetic strip 13 information to the smart chip 14. Cardholder then can input pertinent authentication fingerprints F, picture I, code C and personal information data P using the Writer/Authenticator Input Unit 100.

It is understood the LCD screen 120 for the Writer/Authenticator Input Unit 100 will always be on and will show the phrase “INSERT YOUR CARD INTO THE SLOT WITH CHIP FACING YOU THEN PRESS THE LANGUAGE BUTTON TO CHOOSE PREFERRED LANGUAGE”. The cardholder then presses the language key 124, where the LCD screen 120 asks the user to press the numerical buttons 218 on the codes panel section 214 such as: 1) English; 2) Spanish; or 3) Chinese. Once language number is pressed, the Writer/Authenticator 100 determines whether or not information exists on the smart chip 14 and continuous in the preferred language.

If the Writer/Authenticator Input Unit 100 determines that the chip is empty, it will instruct the user to swipe the card and insert into the slot 210 to copy bank data, which is on the magnetic strip 13 to the smart chip 14 on the credit card 12. The user U then is directed to press the codes function key 216 and inputs the user's credit card PIN number or ATM PIN number for authentication by using the number function key 218. (This is the only time that the ATM PIN number is requested, because that is the only number embedded in the magnetic strip or in the smart chip that can authenticate the cardholder). If the PIN Number does not exist, it will assume the cardholder is the owner and will bypass authentication. The number of PIN input tries is registered with the Writer/Authenticator Input Unit 100. The card holder is given 3 tries to input the correct ATM PIN number, after which a message to see the manager appears on the screen and the red light turns on. When the ATM PIN number matches to that on card, the Green light turns on and the cardholder is instructed, through the user-friendly menu, which appears on the LCD screen 120, to add any or all levels of securities, he/she desires for future authentication.

FIG. 2 shows the Writer/Authenticator Input Unit 100. This unit allows the user to choose and save any finger by pressing the Fingerprint Button 128 first then the finger digit number such as 174 that has numeric indicia “1” on the handprint pad 150 which corresponds with the left thumb, or number 186 which has a numeric indicia of “7” that corresponds with right index finger and so on . . . then placing the corresponding finger on the fingerprint scanner 200 for scanning.

After each successful finger scan, the info green light indicator 204 will turn on, indicating function was completed and saved on the smart chip 14. The user can proceed to the next mode, as shown in STEP 4 (See FIG. 9), where the user can either add more fingerprints, or switch to the picture mode, or add personal code, or utilize the computer to input medical/personal information, by using the fingerprint key 128, the picture key 132, the personal code key 216, and/or the personal info key 136. The cardholder can press the quit function key 144 to exit the system at any time.

If the info red light indicator 202 turns on, when in adding fingerprint mode, that indicates an improper scan. The user U may try again by pressing the fingerprint button 128 and repeating the above. If the cardholder wishes not to use fingerprints for authentication, he/she can press the code button 216, insert personal code and save it. However, authentication without the use of fingerprint will only work when picture and personal code exist on the same smart chip 14. Therefore, after the personal code is entered and saved, it is recommended that the user press the Picture Button 132 and save the picture onto the smart chip 14.

If the Writer/Authenticator Input Unit 100 determines that fingerprints exist in the smart chip 14, the user will be instructed to press any of the lit finger numbers on the handprint pad 150 for authentication. If cardholder mistakenly scans the wrong finger for authentication, the Writer/Authenticator Input Unit 100 will search the fingerprint database that is present on the smart chip 14 for a match (If, However, only personal codes were previously saved on the smart chip 14, user U will be instructed to enter the personal code number C on the number function keys 218 for authentication). Once the cardholder is authenticated to the card, the screen will follow STEP 4 (See FIG. 9) where all saved information (by the cardholder) on the smart chip 14 will be displayed on the LCD screen 120. All saved fingerprints will illuminate on the handprint pad 150. The unlit finger digits will inform the user U of the unsaved fingerprint.

Here again, after a successful completion of each step the green light will turn on, conversely, if the process was not accomplished successfully, the red light will turn on. Once a fingerprint is saved on the smart chip 14, it is permanent and can not be overwritten or removed (picture, Personal code or medical/personal data can be altered at the cardholder's discretion).

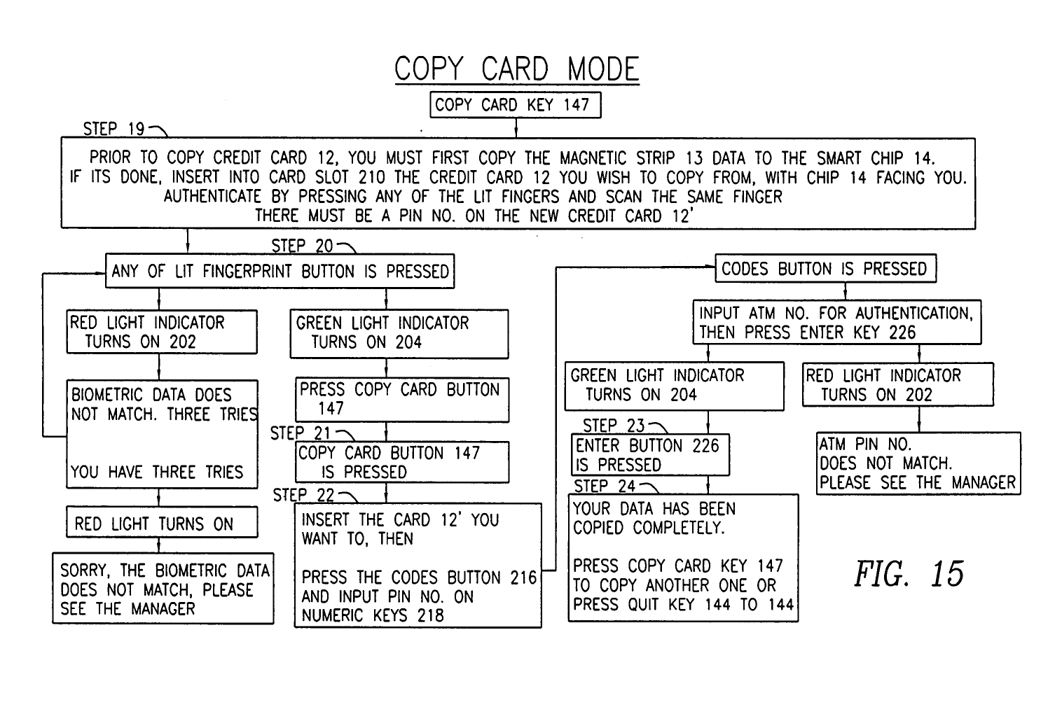

As shown on FIG. 11, after cardholder successfully save fingerprint on the smart chip 14, he/she can easily press the upload button 278 to send the fingerprint data to the computer system 20 for future convenience (Step Z) at his/her discretion. To avoid mistakenly uploading, the LCD screen 120 will ask if the cardholder is sure by pressing Star [*] for “yes” or pound [#] for “no”. Also, if the cardholder wishes to copy inputted data from one credit card to another, he/she presses the Card Copy function key 147 and follows FIG. 15 for STEP 19 to 24. As shown on the last STEP Z, cardholder can press upload button to send the inputted data to the LAN and WAN servers for future convenience.

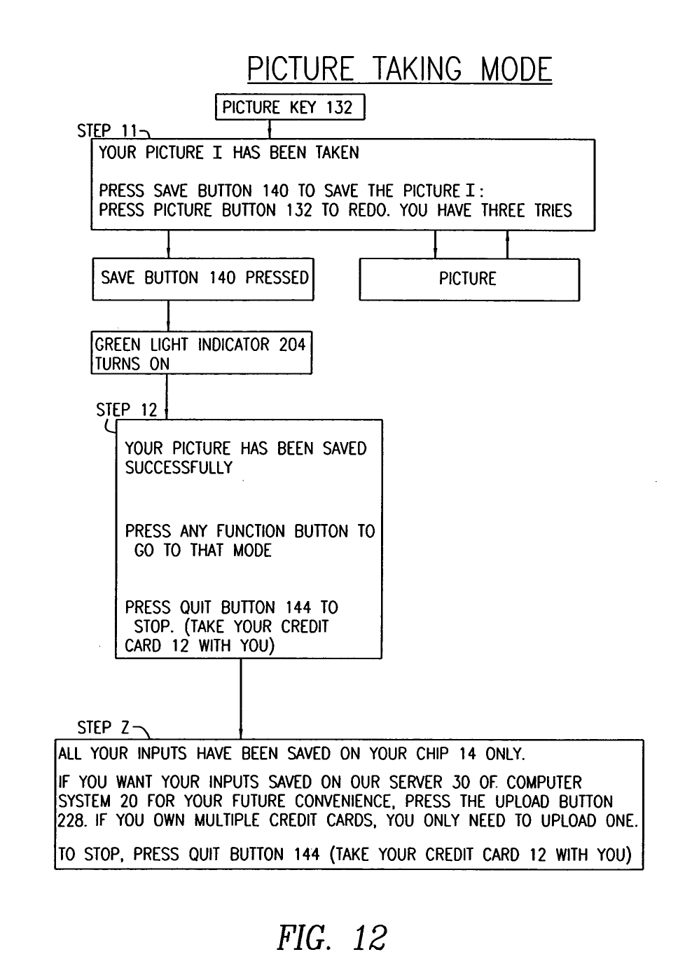

As shown in FIG. 12, the user U can then select and press the photograph function key 132 for taking the user's “head shot” picture using the digital camera 232 and flash 234 built into the Writer/Authenticator Input Unit 100 (See FIG. 2). As shown in STEP 11, the pressing of the picture function key 132 first activates the photo function mode when ready. The user again presses the picture function key 132 for taking the user's photograph I, where then the user presses the save function key 140 to save the photograph I. Optionally, if the user U does not like the photograph, the user U presses the picture function key 132 again (he/she is given three (3) chances to successfully take a picture I). Again, the user U presses the save function key 140 to save the most current photograph I. The info green light indicator 204 will light up, which indicates that the picture I have been saved successfully on the smart chip 14 of credit card or ATM card 12. The user U can now proceed to another menu mode if desired, or can proceed to STEP Z to upload inputted information to the WAN server as previously described, or copy biometric and personal data to a different card.

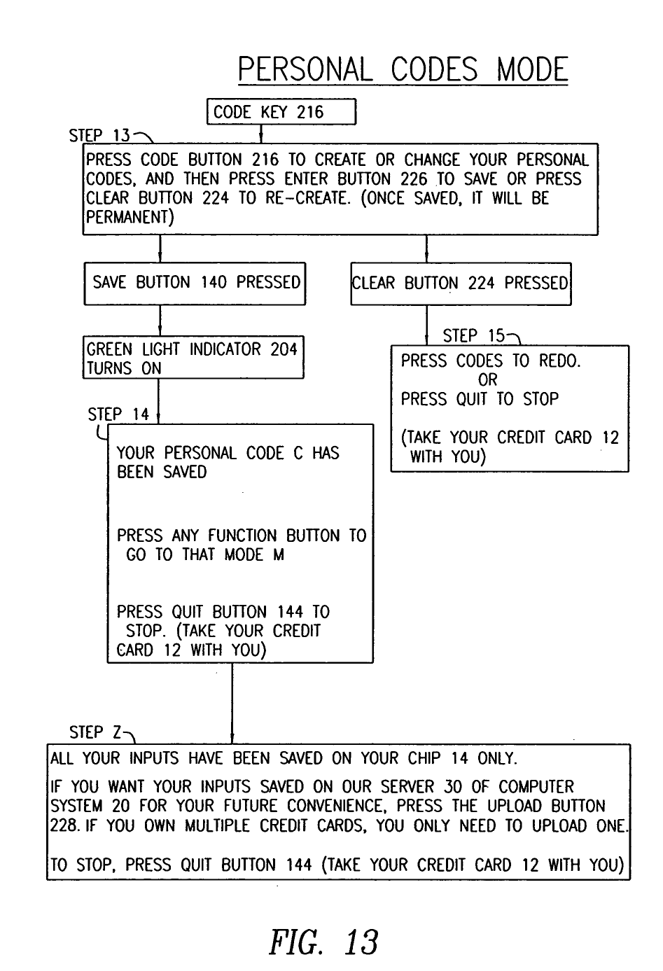

As shown in FIG. 13, the user U can then select and press the code function key 216. The user U is now able to create or change his/her personal codes C, as depicted in STEP 13, where then the user U presses the appropriate number function key 218. The user then presses the enter function key 226 (shown on FIG. 2) to save the new personal code C. Once saved, this personal code is not a permanent data on the smart chip 14 of credit card 12. It can be changed at any time by entering the existing code when the green light turns on, and then entering the new code then pressing the save button 140. Conversely, if the user U does not want that personal code C just entered, the user U presses the clear function key 224 to type in another personal code C. As shown in STEPS 14 and 15, when the personal code C is saved, the user can proceed to another menu mode or press the quit function key 144 to exit and stop the process of inputting data to the credit card or ATM card 12 or the user can precede to the last STEP Z as previously described.

In the event that an ATM PIN number is changed by the bank, the user U can transfer the new PIN number from the magnetic strip to the smart chip 14 by initially swiping the magnetic strip card through 208 then inserting into slot 210. The Writer/Authenticator Input Unit 100 will depicts a different PIN number, and will instruct the user U to be authenticated either through fingerprint or the new PIN Number that is on the magnetic card, or personal code as mentioned above. Once authenticated, the Writer/Authenticator Input Unit 100 will instruct the user to input the new PIN number and press the Enter button to save the new PIN number onto the smart chip 14.

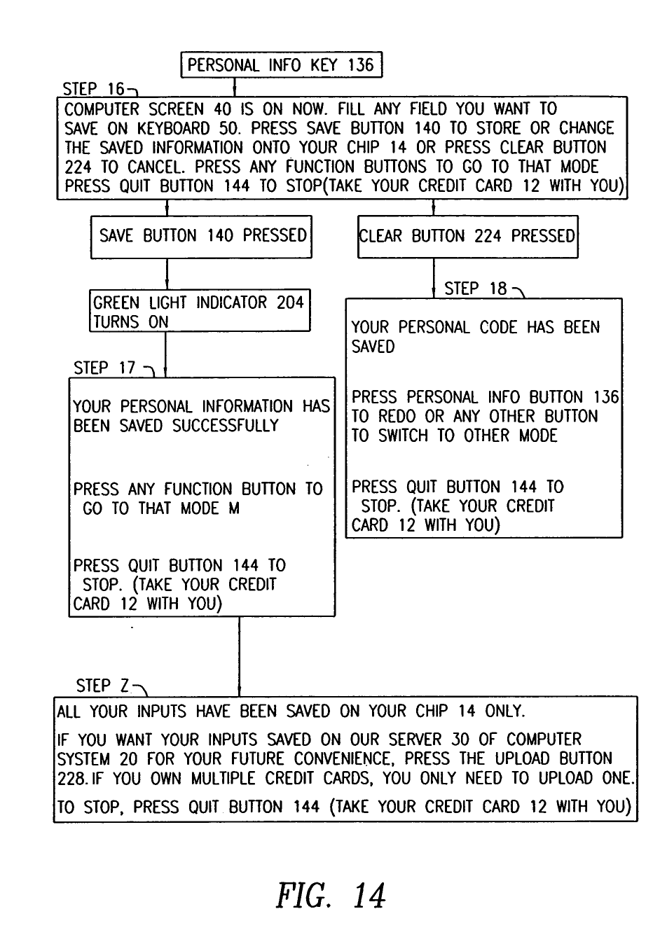

As shown in FIG. 14, the user U can select and press the personal info function key 136. The user U will then be able to input personal information and data P using the computer system 20. As depicted in STEP 16, the computer screen 40 will be on, listing a series of personal info questions from which the user U using the computer keyboard 50 fills in/types in any field he/she chooses to save, such as date of birth, doctor's phone number, allergies, emergency contact etc. The user U then presses the save function key 140 in order to store or overwrite any of the saved information/data P onto the smart chip 14 of credit card or ATM card 12. As shown in STEPS 17 and STEP 18. The illumination of the green light 204 indicates the process was successful. User U can now proceed to another menu mode, or precede to the last STEP Z as previously described or press the quit function key 144 to exit.

As shown in FIG. 15, the user U can select and press the copy card function key 147. The user U will then be able to input any data from the user's first credit card 12 to a user's second credit card 12′ using the original user's data P on magnetic strip 13 and smart chip 14 of original credit card 12. As depicted in STEP 19, prior to copying credit card 12, the user must first copy the data P from magnetic strip 13 to the smart chip 14 of the original credit card 12. Then the user U puts the first credit card 12 into card slot 210 that he/she wishes to copy from, where then the user U authenticates the first credit card 12, by using the fingerprint button key 128, as shown in STEP 20. The user U is now able to copy to a second credit card 12′ by pressing the copy card button/key 147, as depicted in STEP 21. Then the user U inserts the second credit card 12′ into card receiving slot 210 and then presses the codes button 216 and inputs a Pin Number on the numeric key 218, as shown in STEPS 22 and 23, and enters the ATM Pin Number by then pressing the enter function key 226 (see STEP 23) of the new card 12′. As shown in STEP 24, the data processing to the second credit card 12′ has been completed. The user U can then press the copy card key 147 again to copy yet another credit card, or press the quit function key 144 to exit the copy card menu mode.

Once the user's credit card or ATM card 12 having the magnetic strip 13 and smart card chip 14 have saved at least one fingerprint or a personal code, it is useable for authentication for purchases of goods and services. Purchases occur in the following manner. The Vendor/Cardholder unit for vendor 250 and for user 300 is attached to the vendor's counter top V_{C} (next to the vendor's credit card terminal 246 as shown in FIGS. 3 and 4). The vendor V will be facing the vendor unit 250 as shown in FIG. 3 and the user/customer U will be facing the opposite side of the counter top V_{C} of Vendor/Cardholder Unit for user 300 shown in FIG. 4. Connection electrical and phone wires (not shown) are connected to each of Vendor/Cardholder units 250 and 300 internal to the stand 240 in order to communicate with each other. When a customer/user U finishes his/her shopping, the user's credit card or ATM card 12 is swiped in the credit card terminal 246 in the normal manner. The Vendor/Cardholder unit 250 and 300 will electronically intercept the transmission of the credit card or ATM card transaction, the user U inserts same credit card or ATM card 12 with the smart chip 14 facing up, into the insert slot 330. Once inserted, if the red light turns on, it indicates that there is no authenticating information on the smart chip 14. If the green light turns on, it indicates the existence of authentication information. Simultaneously, the cardholder's picture will appear on the screen facing the vender along with the credit card number and expiration date. Vendor/Cardholder 250 has the capability of scanning and saving both fingerprints and codes to the smart chip. If attached to the computer system 20, the personal data P can also be inserted, this function is up to the vendor's V discretion.

As shown on FIGS. 3 and 4, the vendor V has several security options in which to review and authorize a transaction. For example, the vendor V can view the user's photo/picture image I on the LCD screen 270 of the Vendor/Cardholder unit for vendor 250 if the “photo I” was stored on the smart chip 14 of credit card along with the credit card number and expiration date to compare with the transaction receipt or ATM card 12. Vendor at his/her own discretion can press the bypass button 278, after viewing the cardholder picture and expiration date to expedite the transaction. Also, the customer/user can view what fingers 364 to 382 have their corresponding fingerprint(s) F saved on the smart chip 14 which will light up a green color, as shown in FIG. 6. The user clicks on any of the lit finger keys 384 to 402 and scans the particular finger with the fingerprint scanner device 322 on the Vendor/Cardholder unit 300. If the scanned fingerprint F matches the fingerprint F saved on the smart chip 14 of credit card or ATM card 12, the info green light indicator 274 and 334 will be illuminated again on each side of Vendor/Cardholder units 250 and 300, respectively, as such the vendor V will set the transaction to proceed to completion. If the fingerprint F does not match, the info red light indicators 272 and 332 will light up on each side of Vendor/Cardholder units 250 and 300, respectively. The customer U can now try another finger, as he/she might have a cut or dirty finger, the user can change the menu mode to use an inputted code instead. In the event that Writer/Authenticator Input Unit 100 is not available, the Vendor/Cardholder Unit 300 can scan and save the fingerprint(s) to the chip 14 along with personal code C with the vendor V supervising the input. The vendor V can also attach a computer system 20 to the unit 300 at his/her discretion for additional tasks.

As shown in FIG. 7, the Emergency hand-held unit is operated by inserting the cardholder credit card with the smart chip 14 facing up. Once the card 12 is inserted, the unit will turn on and the light 528 will stay on as long as the card is in. If the red light turns on, it indicates there is no medical data on the smart chip 14. However, if the green light turns on, it indicates that information is present in the smart chip 14, and all vital medical data will display on the LCD screen 520 of the hand-held Emergency Reader Unit. The scroll button 526 is for scrolling the data on the screen 520. This unit will only read and show the medical/personal information. It will not display any bank's information.

### ADVANTAGES OF THE PRESENT INVENTION

Accordingly, an advantage of the present invention is that it provides for an authentication system for the authorization of a transaction using a credit card or ATM card which allows the user to select or input multiple layers of security protection totally at the discretion of the cardholder utilizing the self-service Writer/Authenticator Input Unit. Thus elevating the credit card functionality to one that could in an emergency save the cardholder's life.

Another advantage of the present invention is that it provides an authentication system that has the features where cardholders, through the Writer/Authenticator Unit, copy the card's magnetic strip information to the smart chip, scan and save multiple fingers, insert a personal code, take their own picture and save it into the smart chip, and with the aid of the computer and specialized software, insert their medical and emergency data into the smart chip.

Another advantage of the present invention is that the Writer/Authenticator Input Unit is an authentication system that is a biometric comparer and verifier with a user-friendly menu, and red and green indicator lights. It can be used as stand alone or with a computer stationed next to it to input personal and medical information for emergency purpose.

Another advantage of the present invention is that it provides an authentication system having a Writer/Authenticator Input Unit that can search all stored fingerprints automatically if the scanned fingerprint does not match the one stored on the chip.

Another advantage of the present invention is that it provides an authentication system where the Writer/Authenticator Input Unit features a Copying method that copies stored data from one credit card or ATM card to another by first verifying authentication then copying the stored fingerprints, picture, code, and medical/personal data. Data inputted by issuer of identity credential will not be copied.

Another advantage of the present invention is that it provides for an authentication system that includes a Writer/Authenticator Input Unit, a Vendor/Cardholder unit, and an Emergency Reader Unit, all utilizing same protocol and with provision of adding other protocols;

Another advantage of the present invention is that it provides for an authentication system that integrates and engages with the security database that is on LAN or WAN servers.

Another advantage of the present invention is that it provides an Emergency hand-held unit that emergency personal can obtain the credit card, insert into the Emergency Reader Unit and obtain all the vital medical information that could save the cardholder's life without the capability of viewing any bank information.

Another advantage of the present invention is that it provides for an authentication system that can be used by the public in such locations as retailers/department stores, banks, schools, lab testing facilities, office buildings, computer rooms, government agencies, the military branches, emergency personnel such as police officer, paramedics, firemen, doctors at hospitals, ambulance providers, medical end-users and the like.

Another advantage of the present invention is that it provides for an authentication system that provides for a Vendor/Cardholder unit that has the features of a reader, a scanner, a LCD screen that shows the picture of the cardholder with the credit card number and expiration date, a data interceptor, a biometric comparer, and fingerprint and personal code writer, a verifier and a system bypass. Card holder can continue using his/her card that has been used thus far with magnetic strip on it;

Another advantage of the present invention is that the cardholder is the sole proprietor of his card with all biometric and personal information unless he/she personally authorizes the upload of such information.

Another advantage of the present invention is that it provides for an authentication system that can be mass produced in an automated and economical manner and is readily affordable for the vendor.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A method of using an Authentication System for the authorization of a transaction using a credit card, an ATM card or a secured personal ID card (hereinafter “a card”), whereas the Authentication System includes a Writer/Authenticator Self-Service Input Unit, and a Computer System, the method comprising the steps of:
a) inserting a card into a card slot of said Writer/Authenticator Input Unit for activating said Writer/Authenticator Input Unit;
b) activating a language function key for choosing a preferred language;
c) activating one or more fingers of the user on the fingers of a fingerprint pad of said Writer/Authenticator Input Unit;
d) inputting a personal code on a code input section of said Writer/Authenticator Input Unit wherein said personal code was previously saved on said card;
e) inputting additional authorization information into said Writer/Authorization Input Unit by the user by activating one or more of the following menu function modes:
i) a fingerprint function key to add more fingerprints of the user for additional security;
ii) a picture taking function key to add the user's picture for additional security;
iii) a personal code function key to add the user's personal code for additional security; and/or
iv) a personal information function key to add the user's personal and medical information for additional security using said Computer System; for allowing the user to select and add one or more additional layers of security authorization protection to said card; and
f) exiting said Writer/Authenticator Input Unit by activating a quit function key and removing the user's card from the Writer/Authenticator Input Unit.

2. A method of using an Authentication System for the authorization of a transaction using a card having a smart chip selected from the group consisting of a credit card, an ATM card or a secured personal ID card (hereinafter “a card”), wherein the Authentication System includes a Writer/Authenticator Input Unit, a Cardholder Input Unit, a Vendor Unit, and a Computer System, the method comprising the steps of:
a) swiping said card within a swiping slot of a Writer/Authenticator Input Unit and then inserting said card into a card slot of said Writer/Authenticator Input Unit for activating said Writer/Authenticator Input Unit in order to input additional security data of the user onto said smart chip of said card;
b) activating a language function key on said Writer/Authenticator Input Unit for choosing a preferred language;
c) entering the user's ATM pin number onto a code input section of said Writer/Authenticator Input Unit for authentication purposes in order to allow the user to use said Authentication System;
d) inputting additional authorization information into said Writer/Authenticator Input Unit as desired by the user for adding additional security by activating one or more menu function modes:
i) a fingerprint function key to add more fingerprints of the user for additional security;
ii) a picture taking function key to add the user's picture for additional security;
iii) a personal code function key to add the user's personal code for additional security; and/or
iv) a personal information function key to add the user's personal information for additional security in using said Computer System;
for allowing the user to select and add one or more additional modes of security authorization protection to said user's card;
e) exiting said Writer/Authenticator Input Unit by activating a quit function key and removing the user's card from the Writer/Authenticator Input Unit;
f) inserting said card into said Cardholder Input Unit to authenticate the Cardholder; and
g) observing and authorizing use of said card by said Vendor Unit.

3. A method of using an Authentication System of claim 2, comprising the steps of:
a) inserting said transaction card into said Cardholder Input Unit;
b) initiating the authorization process of a particular transaction;
c) viewing one or more lighted finger keys on each of the left and right handprints in order for the authorized user to determine what fingers have corresponding fingerprints saved on said transaction card;
d) scanning one or more of the authorized user's fingerprints on a fingerprint scanner device for authorizing said particular transaction;
e) observing a first light indicator for indicating a successful fingerprint scan or observing a second light indicator for an unsuccessful fingerprint scan;
f) activating said code function key for inputting a preselected authorized code on a plurality of function keys;
g) activating an enter function key for authorizing said authorized code for said particular transaction; and
h) observing said first light indicator for indicating a successful code number entry or observing said second light indicator for indicating an unsuccessful code number entry.

4. A method of using an Authentication System of claim 2, comprising the steps of:
a) observing a photo image (head shot) on an LCD screen of said authorized user by said vendor on said Vendor Unit;
b) viewing the card number on said LCD screen by said vendor;
c) observing said first light indicator for indicating a successful fingerprint scan or observing said second light indicator for an unsuccessful fingerprint scan;
d) viewing the expiration date on said LCD screen by said vendor; and
e) observing said first light indicator for indicating a successful code number entry or observing said second light indicator for indicating an unsuccessful code number entry.

5. A method of using an Authentication System for the verification of information to a medical emergency response using a credit card, an ATM card or a secured personal ID card (hereinafter “a transaction card”) from a user, whereas the Authentication System includes a Writer Authenticator Input Unit, a Computer System, and an Emergency Reader Handheld Unit, the method comprising the steps of:
a) inserting a transaction card into a card slot of said Writer/Authenticator Input Unit for activating said Writer/Authenticator Input Unit;
b) inputting personal medical data and information by the user into said transaction card using said Computer System;
c) activating a personal information function key on said Writer/Authenticator Input Unit to transfer the user's personal medical data from said Computer System to said Writer/Authenticator Input Unit;
d) inserting said transaction card by emergency personnel into a card reader slot on said Emergency Reader Handheld Unit after a medical emergency has occurred to the authorized user in order for said emergency personnel to render medical aid; and
e) activating a display function key for reviewing said user's medical data and information on an LCD screen on said Emergency Reader Handheld Unit by said emergency personnel for medical treatment of said user.

6. An authentication system for the authorization of a transaction card, such as a credit card, an ATM card or a secured personal ID card by a user, comprising:
a) a computer system for inputting personal data and information of the user to said transaction card;
b) a writer authenticator input unit for encrypting said personal data and information of said user into said transaction card for security purposes; said transaction card is defined to include a credit card, an ATM card or a secured personal ID card;
c) a cardholder input unit for the user to insert said transaction card of the user to conduct a transaction; and
d) a vendor unit for use by a vendor for verifying the personal data and information of the user when using said transaction card for completing a transaction.

7. An authentication system for authorization of a transaction in accordance with claim 6, wherein said writer authenticator input unit includes an input unit housing.

8. An authentication system for authorization of a transaction in accordance with claim 7, wherein said input unit housing includes a front panel cover having multiple openings, side walls, and a back wall for forming an interior compartment.

9. An authentication system for authorization of a transaction in accordance with claim 8, wherein said front panel cover includes an LCD screen, a language function key, a fingerprint function key, a picture taking function key, a personal information function key, a save function key, an exit-quit function key and a copy card function key for initiating various processing modes on said writer authenticator input unit.

10. An authentication system for authorization of a transaction in accordance with claim 9, wherein each of said function keys includes a function in-use green light indicator for indicating which of said function keys are being used on said writer authenticator input unit.

11. An authentication system for authorization of a transaction in accordance with claim 8, wherein said front panel cover includes a finger pad section having a pair of left and right handprints thereon.

12. An authentication system for authorization of a transaction in accordance with claim 11, wherein each of said left and right handprints include five finger digits.

13. An authentication system for authorization of a transaction in accordance with claim 12, wherein each of said finger digits includes a finger function key thereon, respectively.

14. An authentication system for authorization of a transaction in accordance with claim 13, wherein each of said finger function keys include a numeric indicia thereon having a light indicator thereon for representing finger digits “1” through “10” being used, allowing the user to match fingerprints of an authorized user.

15. An authentication system for authorization of a transaction in accordance with claim 8, wherein said front panel cover includes a scanner compartment for receiving a fingerprint scanner therein for scanning and storing fingerprints of said authorized user.

16. An authentication system for authorization of a transaction in accordance with claim 8, wherein said front panel cover includes a first light indicator for indicating an authentication processing failure; a second light indicator for indicating a successful processing verification, and a unit power on/off indicator.

17. An authentication system for authorization of a transaction in accordance with claim 8, wherein said front panel cover includes a swipe credit card slot and an insert smart chip card slot for receiving said transaction card therethrough.

18. An authentication system for authorization of a transaction in accordance with claim 10, wherein said front panel cover includes a code input section having a code function key, a plurality of number function keys, a star (*) function key, a pound (#) function key, a clear function key, an enter function key and an upload data function key having said function in-use green light indicator being adjacent thereto; said code input section for inputting of personal numeric codes to said transaction card.

19. An authentication system for authorization of a transaction in accordance with claim 8, wherein said front panel cover includes a digital camera having a flash member being built into said interior compartment of said input unit housing for taking a head shot of said authorized user.

20. An authentication system for authorization of a transaction in accordance with claim 8, wherein said back wall includes an RS-232 port, a USB port, an RJ45 port and an RJ9 phone jack for interfacing with said computer system.

21. An authentication system for authorization of a transaction in accordance with claim 6, wherein said vendor unit for said vendor includes a vendor housing.

22. An authentication system for authorization of a transaction in accordance with claim 21, wherein said vendor housing includes a front vendor panel cover having multiple openings, side walls and a back wall for forming an interior vendor compartment.

23. An authentication system for authorization of a transaction in accordance with claim 22, wherein said front vendor panel cover includes an LCD vendor screen, an info red light indicator, an info green light indicator, and a bypass function key having a function in-use green light indicator.

24. An authentication system for authorization of a transaction in accordance with claim 6, wherein said cardholder input unit for said authorized users includes a cardholder housing.

25. An authentication system for authorization of a transaction in accordance with claim 24, wherein said cardholder housing includes a front user panel cover having multiple openings, side walls and a back wall for forming an interior user compartment.

26. An authentication system for authorization of a transaction in accordance with claim 25, wherein said front user panel cover includes a scanner user compartment for receiving a user fingerprint scanner therein for scanning and storing the fingerprints of said authorized user.

27. An authentication system for authorization of a transaction in accordance with claim 25, wherein said front user panel cover includes a credit card receiver slot for receiving said transaction card therein, an info red light indicator and an info green light indicator.

28. An authentication system for authorization of a transaction in accordance with claim 25, wherein said front user panel cover includes a code input user section having a code function key, a plurality of number function keys, a star (*) function key, a pound (#) function key, a clear function key and an enter function key for initiating said transaction card authorization process.

29. An authentication system for authorization of a transaction in accordance with claim 25, wherein said front user panel cover includes a user finger pad section having a pair of left and right handprints thereon.

30. An authentication system for authorization of a transaction in accordance with claim 29, wherein each of said left and right handprints include five finger digits.

31. An authentication system for authorization of a transaction in accordance with claim 30, wherein each of said finger digits includes a user finger function key thereon.

32. An authentication system for authorization of a transaction in accordance with claim 31, wherein each of said user finger function keys include a numeric indicia thereon having a function in-use green light indicator thereon for representing finger digits “1” through “10” being used, allowing the user to match fingerprints of said authorized user.

33. An authentication system for authorization of a transaction in accordance with claim 25, including means for copying fingerprints from one transaction card to another.

34. An authentication system for authorization of a transaction in accordance with claim 33, wherein said authentication system further includes a counter stand for holding said vendor input unit and said cardholder input unit therein.

35. An authentication system for authorization of a transaction in accordance with claim 34, wherein said counter stand is trapezoidally-shaped and includes a first side wall facing said vendor having a first insert compartment therein for receiving said vendor unit therein, and includes a second side wall facing said authorized user having a second insert compartment therein for receiving said cardholder input unit therein.

36. An authentication system for authorization of a transaction in accordance with claim 35, wherein said vendor input unit and said cardholder input unit are electronically interconnected using internal connection wires within said counter stand for interfacing with each other by intercepting the transaction data sent by the credit card terminal in order to verify the authenticity of said Cardholder.

37. An authentication system for authorization of a transaction in accordance with claim 6, wherein said computer system includes a computer tower, a computer monitor and a computer keyboard for interfacing with said writer authenticator input unit.

38. An authentication system for the verification of information to a medical emergency response using a credit card, an ATM card or a secured personal ID card (hereinafter “a transaction card”) from a user, comprising:
a) a computer system for the inputting of personal medical data and information by the user to said transaction card;
b) a writer authenticator input unit for inputting and encrypting of personal medical data and information of said user to said transaction card for medical emergency purposes; and
c) an emergency reader handheld unit for use by emergency personnel including firemen, paramedics, police officers, doctors, hospitals, or any other kind of medical emergency in which to read and verify the personal medical data and information of said user from said transaction card.

39. An authentication system for the viewing of vital medical information in accordance with claim 38, wherein said emergency reader handheld unit includes a reader housing.

40. An authentication system for the verification of information to a medical response in accordance with claim 39, wherein said reader housing includes a front reader panel cover having multiple openings, side walls and a back wall for forming an interior reader compartment.

41. An authentication system for the verification of information to a medical response in accordance with claim 40, wherein said front reader panel cover includes an LCD screen, an info red light indicator, an info green light indicator, a scroll function key and a function in-use blue light indicator.

42. An authentication system for the verification of information to a medical response in accordance with claim 40, wherein one of said side walls includes a reader card slot for receiving said transaction card of said user.

43. An authentication system for the verification of information to a medical response in accordance with claim 40, wherein said back wall includes a battery opening having a battery cover thereon, and a battery compartment within said interior reader compartment.

44. An authentication system for the verification of information to a medical response in accordance with claim 43, wherein said battery compartment is used to receive standard batteries such as AA batteries, AAA batteries or a 9 volt battery for powering of said emergency reader handheld unit.
